(19) United States
(12) Patent Application Publication
(10) Pub. No.: US 2006/0283564 A1
(43) Pub. Date: Dec. 21, 2006

(54) RETRACTABLE SCREEN DOOR HOUSING HANDLE BALANCING SYSTEM

(76) Inventor: John Poppema, Langley (CA)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/424,335

(22) Filed: Jun. 15, 2006

Related U.S. Application Data
(60) Provisional application No. 60/691,439, filed on Jun. 16, 2005.

(51) Int. Cl. E06B 9/24

(52) U.S. Cl. 160/371

(57) ABSTRACT

A horizontally extending screen door system having balancing cords that pull in a direction that opposes the force on a handle by the screen exerted by the wind up mechanism of the screen.

### RELATED APPLICATIONS

This application claims priority benefit of U.S. Ser. No. 06/691,439, filed Jun. 16, 2005.

### BACKGROUND

Screen doors fitted to the perimeter regions of windows and doors have long been a commodity in households as well as businesses. Certain types of screen doors that have upper and lower track members and some form of a housing generally attempt to lock in a screen door handle in some fashion in an open position where the screen is withdrawn. One form in the prior art of locking such a screen is to lock a handle in the upper and lower portions along a guide rail. However, the handle which is adapted to extend the screen from some form of the base housing is not well adapted to address any form of moment (torque) about a transverse axis. In other words, there is tremendous possibility for a handle to rotate about an axis orthogonal to the plane of the screen thereby having a “cockeyed” handle with respect to the stationary frame items. This problem is amplified in situations where the screen places a tension in a first direction upon the handle and some form of lateral force in the second lateral direction must withstand this tension to keep the screen open. Further, it is desirable to have the screen shut and have some form of a spring to wind up the screen within a housing in a stored position.

One particular problem with repositioning a screen from an open position to a closed position is trying to finesse an equal amount of force to counteract the “holding force” to position the handle and screen in an open orientation with the screen extended. Normally the holding force is some sort of fractional engagement or temporary locking engagement such as extending some sort of knob around a constructed portion where the constructed portion slightly expands to have the knob extension fit therein. Of course this generic description can address a plurality of types of prior art mounting systems but the gist of such a mechanical apparatus requires some form of deformation of material to lock and unlock the handle to and from the open position. This generally requires perhaps some form of inertia or at least a focused amount of force with holding the handle in such an open position.

In other words, when opening a handle in prior art forms, there is some form of snapping action to lock such a handle open to counteract the force of the spring winding up a screen. It has been found to be problematic that when trying to close the screen, one of the two locking members at the upper lower portions will disengage while the other locking member remains engaged, causing the cockeyed arrangement of the handle which is very undesirable. Further, given the constraints of the ability to place reinforcement members to prevent such a situation, there appears to be little hope for preventing such misalignments of the handle from occurring. Further, once the handle is past the high resistance on any locking portion, there is essentially a lengthy free pull where the tension in the spring can translate the force therealong the screen and the handle accelerates until slamming up to the base housing. Such an impact can cause injury to toes and fingers as well as cause general wear and tear on the screen assembly and possibly cause damage thereto.

Therefore, it is desirable to provide a system where a handle can remain open or even at intermediate locations where a counterbalancing force will occur at a plurality of locations and not just at an extreme open location. Such a system is desirable to allow for intermediate positioning of the handle, preventing a slamming action of the handle and to further aid in preventing any cockeyed arrangement of the handle with respect to the upper lower housing members.

### SUMMARY OF DISCLOSURE

With the foregoing background in mind, it can be appreciated that providing an extractable handle horizontal balancing system is very desirable where a handle horizontal balancing system is adapted to be fitted to an upper guide member and lower guide member. Essentially, in one form the balancing system comprises a balancing cord and first and second ends attached to second lateral portions of upper lower guide members. There is a stationary pulley assembly within the handle as well as a movable pulley assembly where the movable pulley assembly has positional tension applied thereto. In other words, the movable pulley assembly is biased to move in a certain direction. The balancing cord extends around the pulley in a block and tackle like fashion and further extends around the upper and lower extremity portions of the handle thereby extending along the upper and lower guide members to the end portions where they are fixed thereto. The arrangement is such that when the handle has been repositioned to a closed position and the screen is beginning in the wound up, the pulleys will reposition towards one another and a biasing member will extend, resisting such movement. In other words, the balancing cord will place a tension that opposes the tension of the screen. Of course there are various other features and components of assemblies and systems which are described further herein in detail.

In general, the handle horizontal balancing system is adapted to place a force upon the handle housing in a first lateral direction as indicated by the lateral axis. Having a substantially relatively long handle housing to accommodate the passageway presents a challenge to provide stability to the handle housing so it does not rotate about a transverse axis. This challenge is presented because one can appreciate that given the nature of the retractable screen door in one orientation has a closed position where the handle is positioned in the first lateral portion whereby the screen is closed and retracted within the screen retraction system. Further, in operation, the retractable screen door assembly has an extended position whereby the handle housing is extended in the second lateral direction towards the perimeter portion to fully extend the screen.

The nature of attaching the handle housing to the upper and lower guide/bracketing members, is to provide a relatively compact system whereby in general there is not much capability of structurally providing supports in the upper and lower portions of the handle housing to the upper and lower guide members. In other words, general principles of fundamental mechanical engineering indicates that it is difficult to handle a moment about a transverse axis at the connection points between the handle housing and the guide members. To keep the handle housing in an open position, the handle housing locks somehow to some structural portion in the second lateral direction away from the base housing. In one form, with a system that does not provide any structure between the upper and lower guide members in the second lateral region, only provides attachment at the upper and lower portions of the handle housing. Therefore, providing a locking system which maintains a lateral resistance from the pull of the retractable screen 48 has traditionally been found to be a challenge. By locking the handle housing 46 to both the upper and lower guide members in the open position, an issue arises were when retracting the screen door; one of the locking portions will engage and the other will disengage thereby creating a “cockeyed” arrangement where the handle housing is skewed and essentially rotates about a transverse axis.

Therefore, by providing a horizontal force in the lateral direction to balance out the handle housing, a very desirable situation is created where the handle housing is substantially balanced from the pull of the balancing cord and a counteracting pull by the handle horizontal balancing system.

### BRIEF DESCRIPTION OF THE DRAWINGS

FIG. 1 is an isometric view of the screen door system;

FIG. 2 is taken along line 2-2 of FIG. 1 showing in cross-sectional view the handle and the base housing;

FIG. 3 shows the base shell portion of the base housing mounted to the lower base where a double-threaded screw is extended through the base shell, and set apart from the lower base region is the L-shaped base shell set aside illustrating how the L-shaped base shell fits to the lower base;

FIG. 4 shows the base housing in two components where the outer shell is adapted to be rotatably mounted to the base shell;

FIG. 5 shows a locking extension being fitted within a longitudinally extending slot of the L-shaped base shell;

FIG. 6 shows the outer shell being rotatably attached to the L-shaped base shell;

FIG. 7A shows a screen retraction assembly in a sectional view;

FIG. 7B shows a top sectional view taken at line 7B-7B in FIG. 7 of the screen retraction assembly showing how the inner plug repositions vertically therein the inner rod;

FIG. 8 shows a front environmental view of the unit showing the interior cord elongation assembly 186 in a hatched-like line;

FIG. 9 shows a partial sectional broken view showing the upper and lower bracketing components attached to the handle where the handle is shown in a partial sectional view illustrating the cord elongation assembly which in one form is a block and tackle pulley-like assembly;

FIG. 10 shows the side view of the first pulley member;

FIG. 11 shows the distal end cap of each of the upper and lower bracketing components showing the access port exposing the interior locking extensions;

FIG. 11B shows the end lock of the balancing cord being fitted to hit the locking extensions, which occurs in one form when the door is first configured and opened fully in a fully extended manner;

FIG. 11C shows the end lock of a balancing cord fixedly attached to the distal end;

FIG. 12 shows a sectional view of one form of the bracketing component taken at line 12-12 of FIG. 9;

FIG. 13 schematically shows the cord elongation assembly, which in one form is a block and tackle like assembly with upper first and second pulley members; this figure schematically shows the one arrangement of a single piece of cord to extend around the block and tackle assembly and operate and extend to upper and lower portions of the handle;

FIG. 14 shows the handle in a screen closed orientation where the first and second pulleys are positioned in closer proximity to one another and the biasing springlike member is in an extended configuration;

FIG. 15 schematically shows another embodiment where first and second biasing springlike members are utilized where both of the block and tackle assemblies are movingly positioned within the interior chamber of the handle;

FIG. 16 shows another embodiment where one of the block and tackle assemblies is positioned above the handle, and the various cords pass around a handle portion of the unit;

FIG. 17 shows yet another embodiment where upper and lower biasing members are utilized and the balancing cords are directly withdrawn within the biasing members;

FIG. 18 shows another embodiment where two springlike members are positioned at either portions of the handle and extend around the opposing end regions to supply a balancing force upon the handle;

FIG. 19 shows another embodiment where a cord-like member is attached to the end portion of the handle and extends around the pulley to bias the handle in the first lateral direction;

FIG. 20 shows another embodiment where a balancing cord in one form is configured of an incompressible-like structure, such as a chain link, to extend the handle in a first lateral direction to counter the force of the screen pulling in a second lateral direction;

FIG. 21 shows yet another embodiment of an internal biasing system where at least one biasing component is attached to two lines that extend to upper and lower portions of the handle to place a force in the first lateral direction upon the handle to counteract the pull of the spring in the second lateral direction

FIG. 22 shows another embodiment of a biasing member, which in this form is a partial constant force spring;

FIG. 23 shows a bottom view of the biasing member

FIG. 24 is taken at line 22-22 of FIG. 21 showing a cross-sectional wind-up spool;

FIG. 25 is a front view of the unit of the biasing member;

FIGS. 26 and 27 are side and top views of the wind-up spool.

### DESCRIPTION OF THE EMBODIMENTS

Throughout this description reference is made to top and bottom, front and rear. The apparatus of the present invention can, and will in practice, be in numerous positions and orientations. These orientation terms, such as top and bottom, are obviously used for aiding the description and are not intended to limit the invention to any specific orientation. Specifically, the apparatus 20 can be mounted to either the left or right side of a door opening there for the screen dispenser 26 will be employed with the racheting region at either the upper or lower locations.

In the following text, there will first be a description of the overall operations of the apparatus of the present invention followed by a detailed description of the preferred embodiment of the present invention.

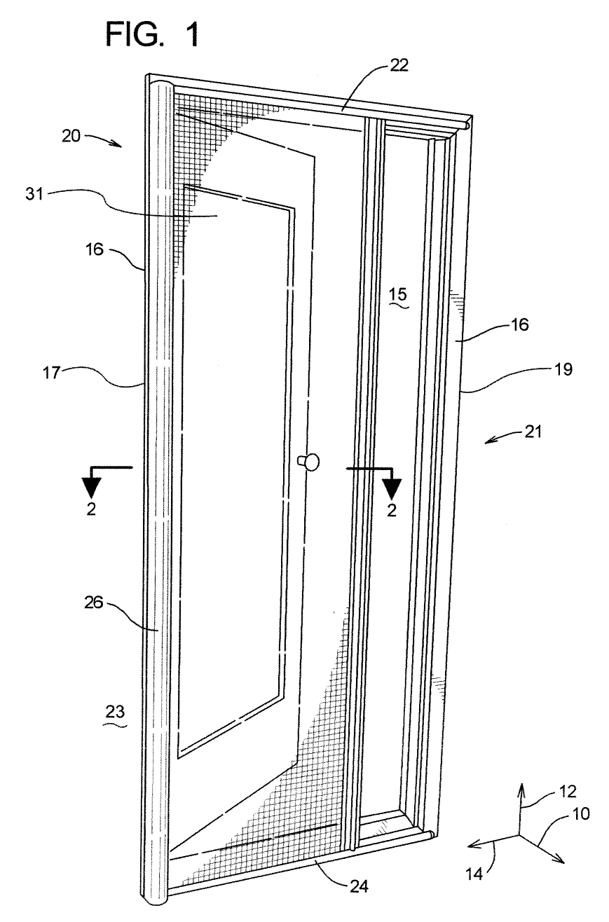

To aid the description orthogonal directions are defined shown in FIG. 1, where axis 10 indicates a transverse direction, axis 12 indicates a vertical direction, and axis 14 indicates the lateral direction. The direction of the arrow in axis 10 is referred to as an “outward” direction on the transverse axis with a diametrically opposed direction is herein referred to as the “rearward” direction.

The apparatus of the present invention is a slidable door system that can be mounted to any number of doorframes and exterior sills. The apparatus is particularly advantageous for screen doors.

The apparatus 20 of the present invention is a retractable screen assembly (designated 20) which in turn comprises a mounting frame or housing 81, and a retractable screen 22 which, as its name suggests, has a retracted position where it is rolled up and located within a portion of the perimeter frame 21, and an extended position where it has been pulled outwardly from the frame and extends across the open area within the perimeter of the mounting frame. In the preferred embodiment shown herein, the retractable screen assembly 20 is shown as a retractable screen assembly for a doorway. However, it is to be understood that the basic design of the present invention could be used in other applications, such as providing a retractable screen assembly for a window, and different types of doorways or other access openings for homes, buildings, etc. In general, the environment of the retractable screen door assembly 20 comprises a passageway 15 positioned on some form of a building 23 such as a dwelling or commercial establishment, the passageway containing first and second perimeter regions 17 and 19. The passageway further comprises an upper perimeter portion and a lower perimeter portion. Further, the passageway 15 in most forms comprises a door 31 which normally is a hinged door or, in certain embodiments, a French double door. Of course, the retractable screen door assembly 20 is adapted to operate and retrofit to a plurality of types of passages 22 but provides particular advantages of allowing a relatively discreet screen door which is desirable in many climates allowing air passage therethrough while blocking insects and vermin from entering the structure 23.

The perimeter mounting frame 21 in turn comprises upper and lower laterally aligned bracketing components 22 and 24 located at the upper and lower locations, respectively, of the doorway or other opening, and a substantially vertical screen retaining and dispensing component 26 (hereinafter called the “screen dispensing component” mounted at one side of the doorway).

The main function of the screen retaining and dispensing component 26 is to contain the screen in a rolled up retracted position and enable the screen to be extended therefrom, and the main function of the upper and lower bracketing components 22 and 24 is to provide upper and lower slideways along which the upper and lower edge portions of the screen member 22 can be guided as the screen member 22 moves between its retracted position and its extended position, and also to retain the screen member 22 in its extended position.

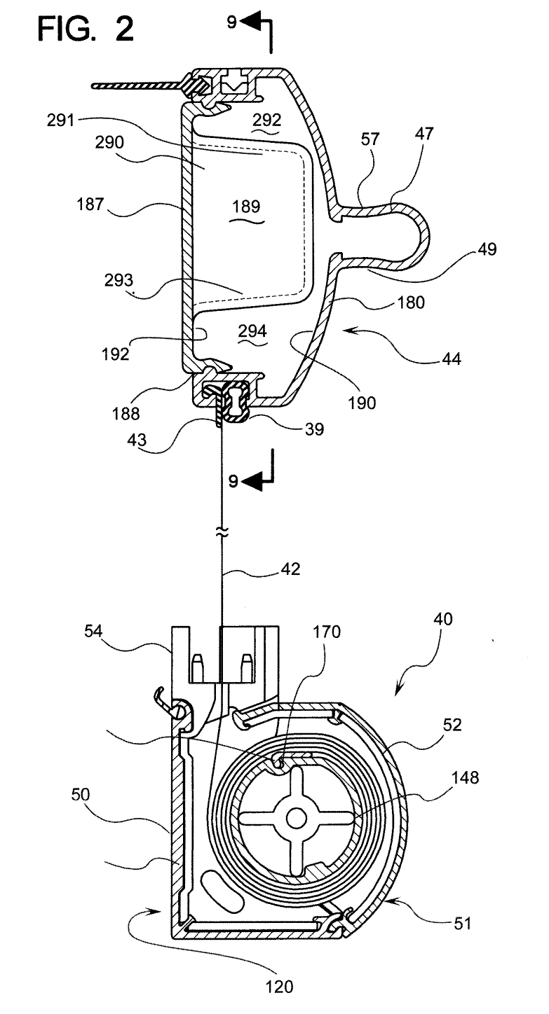

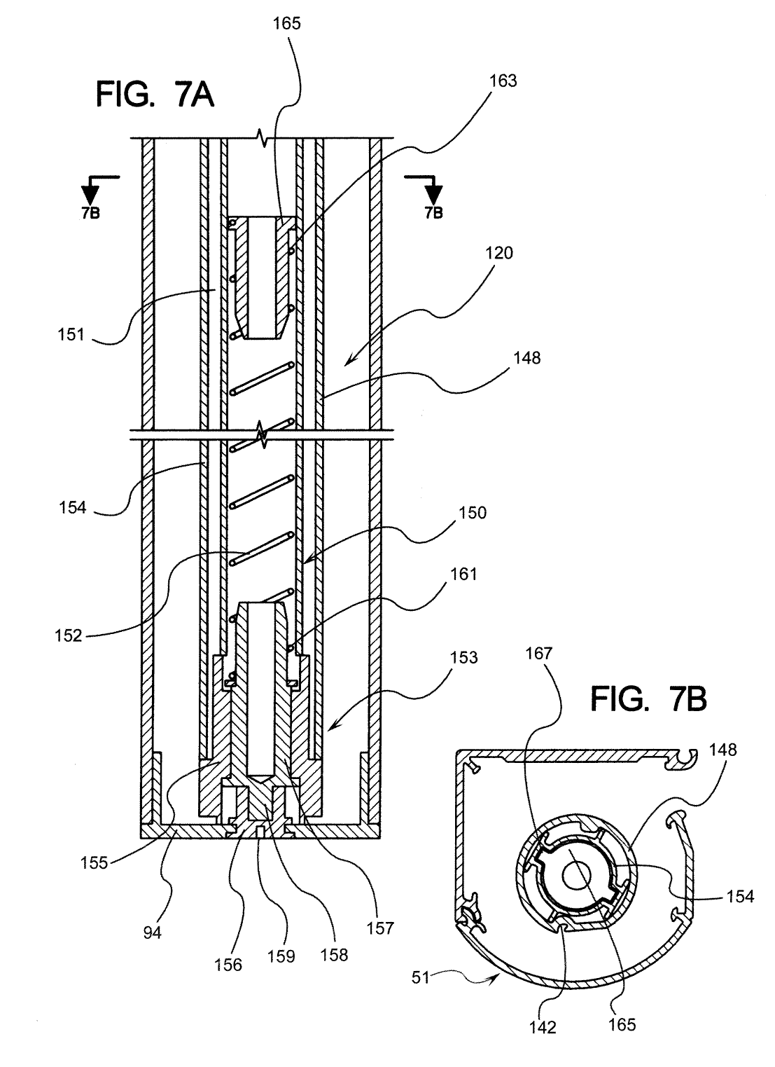

Now referring to FIG. 2, there is shown a sectional view taken at line 2-2 of FIG. 1 showing the screen dispenser 40, the screen 42, and the handle 44. The handle 44 will be discussed in detail where a block and tackle assembly is positioned therein to provide a counteracting force upon the handle to substantially balance the pulling force from the screen 42. The cord retraction system 120 will be discussed further below with reference to FIG. 7.

In general, the screen dispenser 40 comprises the base shell 50, the outer shell 52, a lower end cap shown in FIG. 2 as 54, and an upper end cap that is of a similar construction of the lower end cap which are both adapted to receive the upper and lower bracketing components 22 and 24 described herein. Of course, the construction of the lower and upper caps can be a variety of sorts to properly provide an upper and lower bracketing component to extend in the lateral direction.

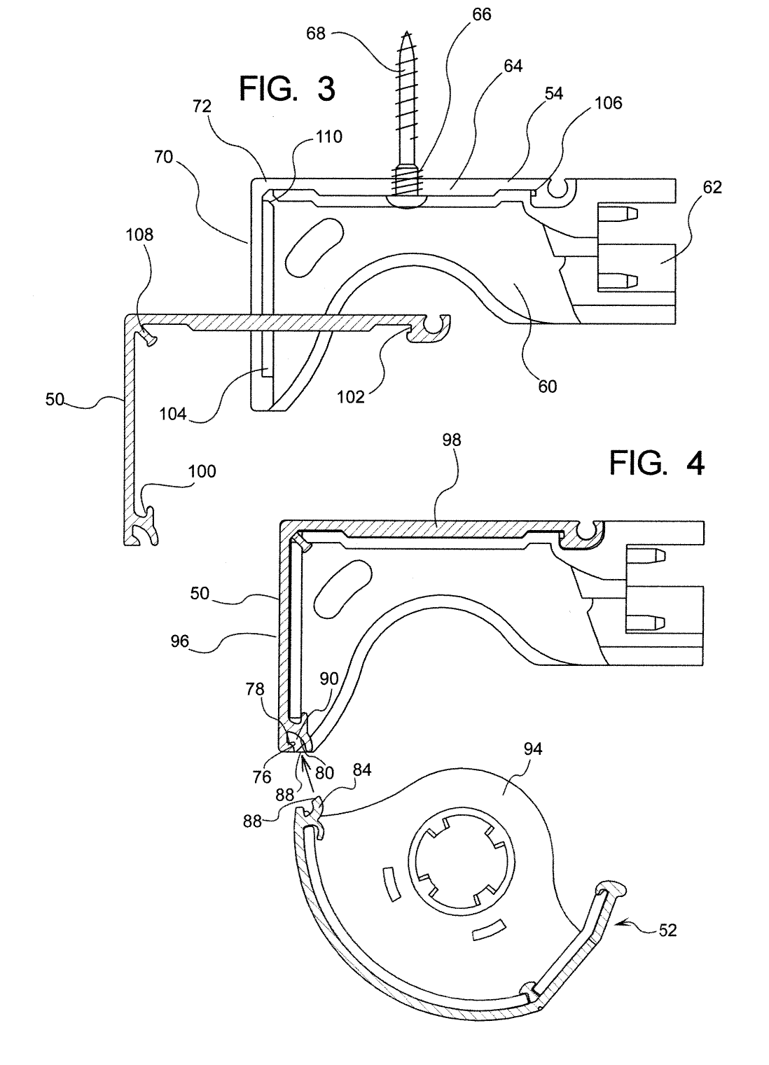

As shown in FIG. 3, the lower end 54 comprises a lower base region 60 and a bracket receiving portion 62. The rear wall of the base shell 50 provides a surface to allow an opening 66 for a dual-headed screw 68 to pass therethrough. The concept of the dual-headed screw is thoroughly discussed in the application by the same inventor for U.S. Pat. No. 6,478,070 which is fully incorporated by reference. The lateral portion 70 extends in the transverse direction, and the rear wall 64 and lateral portion 70 define a recessed region 72 to mount the base shell 50 thereto. FIG. 3 shows the base shell 50 slightly displaced from the lower end cap 54, whereas FIG. 4 shows the base shelf 50 positioned thereabove in a locked-in configuration.

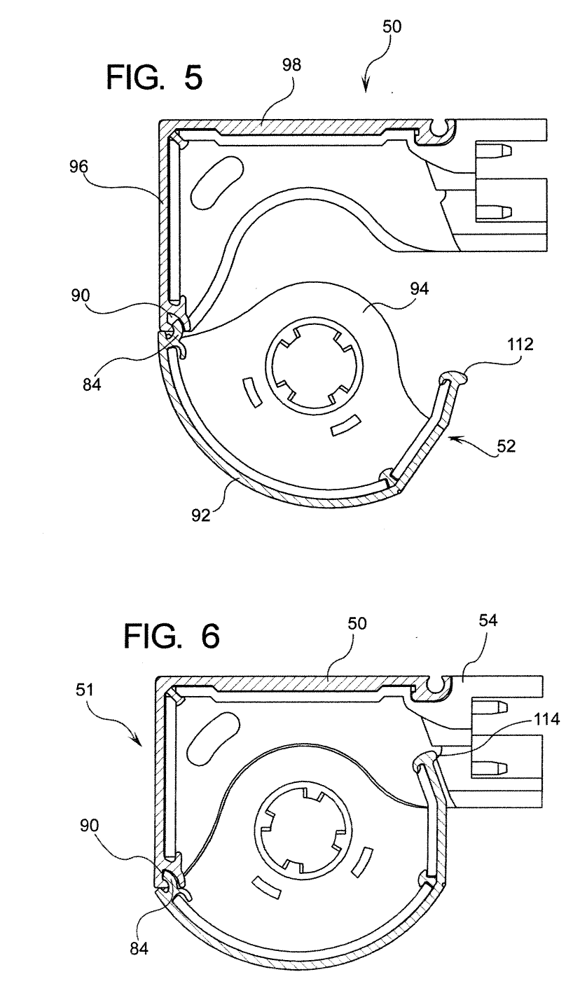

Now referring to FIG. 4, there is shown the outer shell 52 operatively configured to engage a longitudinally extending slot 76 extending along the transversly extending member 55. In a preferred form, the longitudinally extending slot has the first radial surface 78 and the second radial surface 80, both which are, in a preferred form, substantially partially cylindrical in nature and adapted to receive the locking extension 84. The locking extension 84 has a partial cylindrical shape where the forward portion 86 is adapted to engage the surface defining the longitudinally extending opening 88, where as shown in FIG. 5, the locking extension 84 is partially within the longitudinally extending chamber portion 90 and operatively configured to partially rotate therein to a locked configuration as shown in FIG. 6. The lower base of the outer shell 52, in one form, is a separate piece from the shell region 92. The lower base cap 94 in one form can be, for example, a plastic piece which snaps to the lower portion of the shell region 92, which can be an extruded portion of aluminum.

Referring to FIG. 5, the base shell 50 comprises a transversely extending portion 96, and a rear wall 98. The recessed portions indicated at 100 and 102 are adapted to engage the small extension portions 104 and 116 of the lower end cap 54. Further, the corner extension 108 can fit within the recessed portion 110 to snugly fit the end caps thereto. Of course, any kind of extension and locking system can be utilized, and in one form, the base shell is comprised of components, but of course could be comprised of any number of components or be constructed of a single unitary unit.

Referring ahead now to FIG. 6, it can be seen that the base shell 50 is presumably fixedly attached to a door perimeter in one form by a perimeter region of an opening with a screw or the like. As described above, a preferred method of fixedly attaching is using the dual-headed screw to properly space from the perimeter region, which is thoroughly described in U.S. Pat. No. 6,478,070, which as noted above is incorporated by reference and provides some background information on one method of installing the unit. Of course, any method can be utilized for installing the base structure.

FIG. 6 illustrates how the locking extension 84 fits within the chamber region 90 defined by the first and second radial surfaces 78 and 80, which is best shown in FIG. 4. This rolling-like action allows for a lever-like effect so the locking extension 112 of the outer shell 52 engages some portion in the end cap, and as shown in FIG. 6, the lower end 54. For example, the slight recessed portion 114 is adapted to receive the locking extension 112 and virtually engage thereto. Of course, any number of types of locking mechanisms can be utilized, but have a slight inward deflection of the screen of the outer shell 52, and having the locking extension 112 temporarily displace radially inwardly, and then extend radially outwardly to snugly fit within the recess 114. This is one desirable method of locking the unit together so the entire structure of the outer shell 52 and the base shell 52 comprises the base housing, generally denoted by numeral 51. Of course, it should be noted that in one form, as shown in FIG. 4, the first and second radial surfaces 78 and 80, which are vertically oriented along the path (or at least a portion of the length) of the base shell 50 in one form are partially cylindrical in nature. Of course, any number of surfaces between the locking extension 84 and the surfaces 78 and 80 can be utilized to allow a rotating-like effect of the outer shell 52 to properly engage and lock to the upper and lower portions of the screen door system 20. Of course, it should be noted that in one preferred form, the vertically extending components are extruded, and the end portions can be, for example, plastic injected components. This allows for one method of manufacture. It should also be noted, with reference to FIG. 6, that the extension 114 has a certain amount of flex to it as it rotates about the rotation point defined near the locking extension 84.

As seen in FIGS. 7A and 7B, the screen retraction system (or dispensing and retracting mechanism) 120 comprises an elongate tube 148 and a spring system 150. The spring system 150 has a first portion 151 and a second portion 153 comprising the spring 152 (more particularly the second end 163 of the spring 152), inner rod 154, end cap 155 and the inner plug 165. The inner rod 154 has an extension region 158 discussed further herein. The spring 152 has a first end 161 is rigidly attached to the first portion 151 of the spring system 150 to the inner plug 165 that is described further herein. The vertically opposite portion of spring 152 at the spring first end 161 is rigidly attached to the static plug 157.

In operation the first portion 151 of the spring system, namely the elongate tube 148, the inner rod 154, the inner plug 165 and the upper portion of the spring 152 (the spring's second end 163) all rotate to unwind and wind up the screen (not shown) that is wrapped around the elongate tube 148. Therefore the end cap 155 rotates around the static plug 157.

When adjusting the spring tension, the adjustment cap 156 will rotate in the direction to increase the torsional tension of the spring. In FIG. 7A looking from the bottom this would be a clockwise rotation. The inner surface of the cap 155 is adapted to be received by the static plug 157. Therefore the entire elongate tube 148 rotates with respect to static plug 157. The extension 158 is adapted to be received by adjustment cap 156. Therefore adjustment cap 156 will rotate the static plug 157 when adjusting the tension of the spring 152. The adjustment cap 156 has a plurality of tangentially inclined ridges that are adapted to engage the forward portion of ridges in a ratcheting region of the lower base cap 94 discussed above. A central surface 159 creates a recessed region that is adapted to receive the head of a screwdriver for adjustment discussed further herein.

The elongate tube 148 as shown in FIG. 2 has an indentation 170 extends vertically along the outer surface and is adapted to receive the flange 142 on the spline 140 of the screen 118. The replacement of the screen 118 can be accomplished very easily by removing the elongate tube 148 from the outer shell 112 and removing the spline 140 from the indentation 170. The screen is further removed from the handle 115 by removing the bumper 222 from the connection region 202.

Referring now to FIG. 7B it can be seen that the inner plug will vertically extend within the inner rod 154 while different tensions are applied to the spring during operation (as well as adjustment). By allowing the second end 163 of the spring to vertically reposition within the inner rod 154 it has been found that the noise produced by the spring system 150 has been reduced. The lateral extensions 167 are received by the indentation portion of the inner rod to transfer torque therebetween. The inner rod can be a single unitary unit with the elongate tube 148; however, in one form of manufacture these are separate units. The various flanges of the inner rod 154 engage inward extensions of the elongate tube 148 and further can frictionally engage therein.

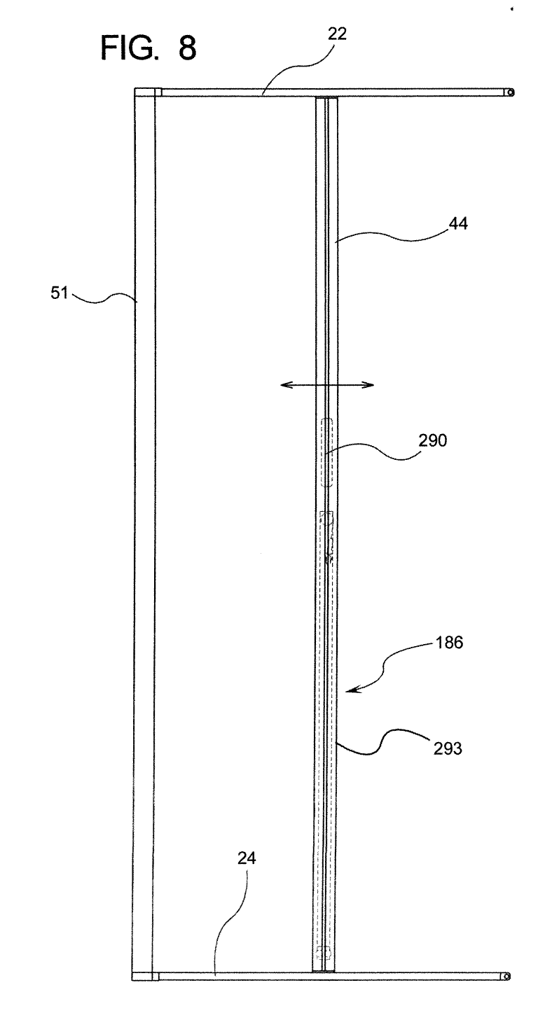

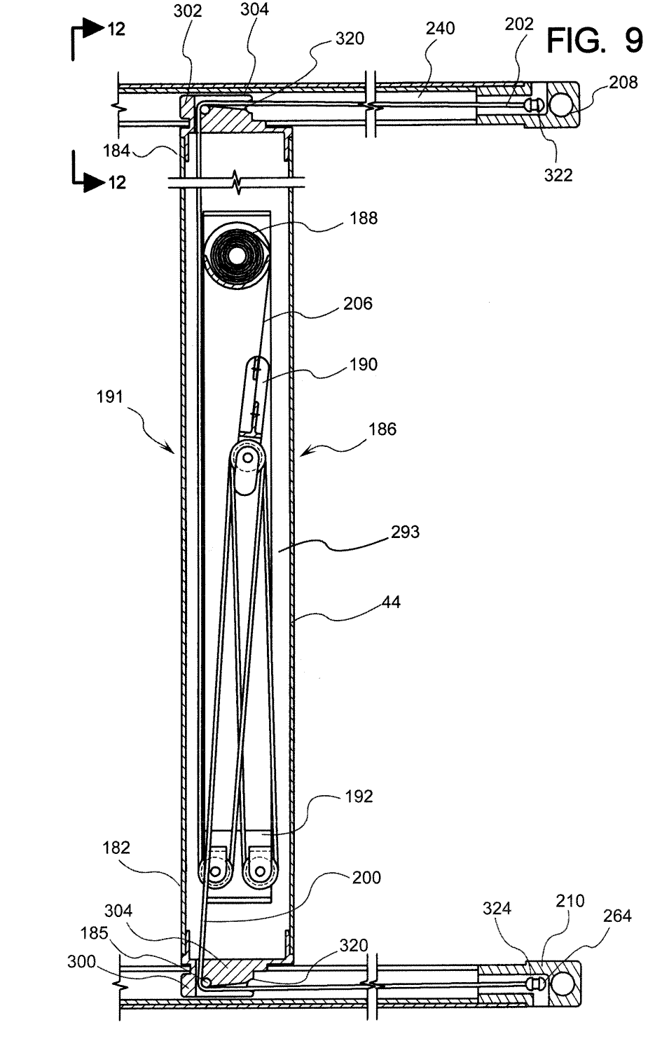

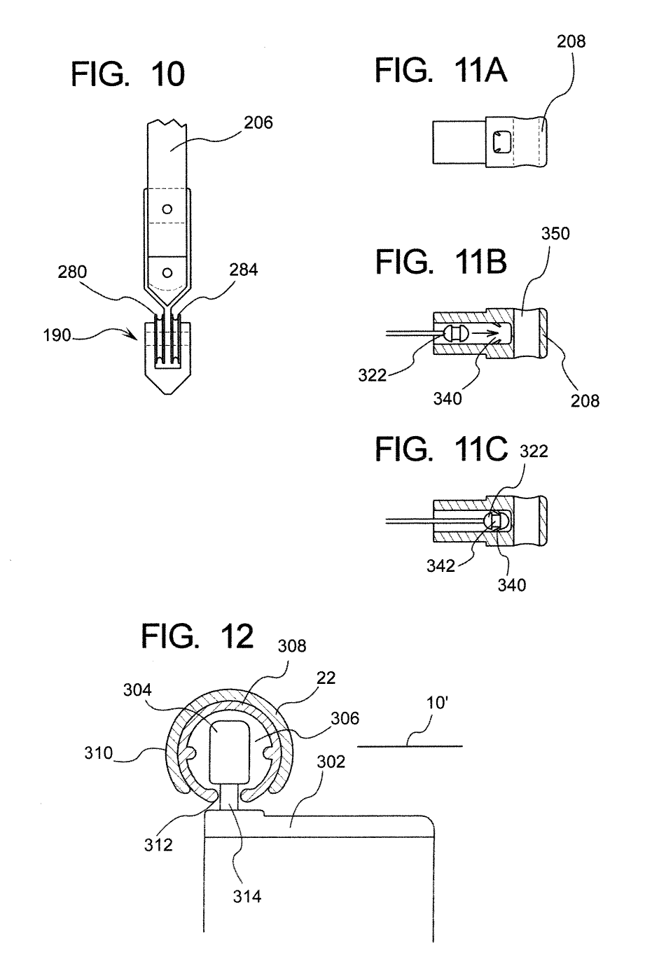

With the foregoing description in place, there will now be a discussion of the handle 44 which is shown in a front environmental view in FIG. 8. Referring back to FIG. 2, it can be seen how the handle member 44 extends substantially in the vertical direction. As shown in FIG. 2, the handle 44 comprises the elongate structure 180 which extends from the lower portion of the handle 182 as shown in FIG. 9 to the upper portion 184. An insert plate 187 is positioned in the substantially open portion 188 of the elongate structure 180. The handle 44 has an inner surface 190 which is a portion of the elongate structure 180 as well as an inner surface 192, which in one form is a portion of the insert plate 187. The interior surfaces 190 and 180 form an interior chamber which is adapted to house the cord elongation assembly 186, as best shown in FIG. 9. In general, the cord elongation assembly is adapted to take up slack of the cord 200, which in one form is a continuous loop extending from one first end 202 to a second end 204. The cord elongation assembly 186 generally comprises the aforementioned cord 200, a biasing member 188, a first pulley member 190 and a second pulley member 192. The first and second pulley members 190 and 192 should generally comprise a pulley system 191, which in one form is a block-and-tackle-like pulley system where multiple pulleys are utilized to provide extra extension of the first and second ends 200 and 204 as they extend from the handle member 44.

The handle member as shown in FIG. 2 has the extension 47, which extends vertically and can have rearward and forward surfaces 49 and 57 to allow repositioning of the unit. The handle indentation 290 in one form can be a portion of the handle to allow movement of the block and tackle assembly at upper or lower portions. The handle indentation 290 again has forward and rearward surfaces 291 and 293 for supplying a force thereto.

The first end 43 of the screen extends vertically along the handle 44. As shown in FIG. 2, and in one form the bumper 39 fits the first end therein to be held in place. Of course, the bumper can also absorb some impact when the screen is shut although with the balancing system in place, the screen dispenser 40 does not exert as much, if any, acceleration on the handle to prevent the door from slamming shut.

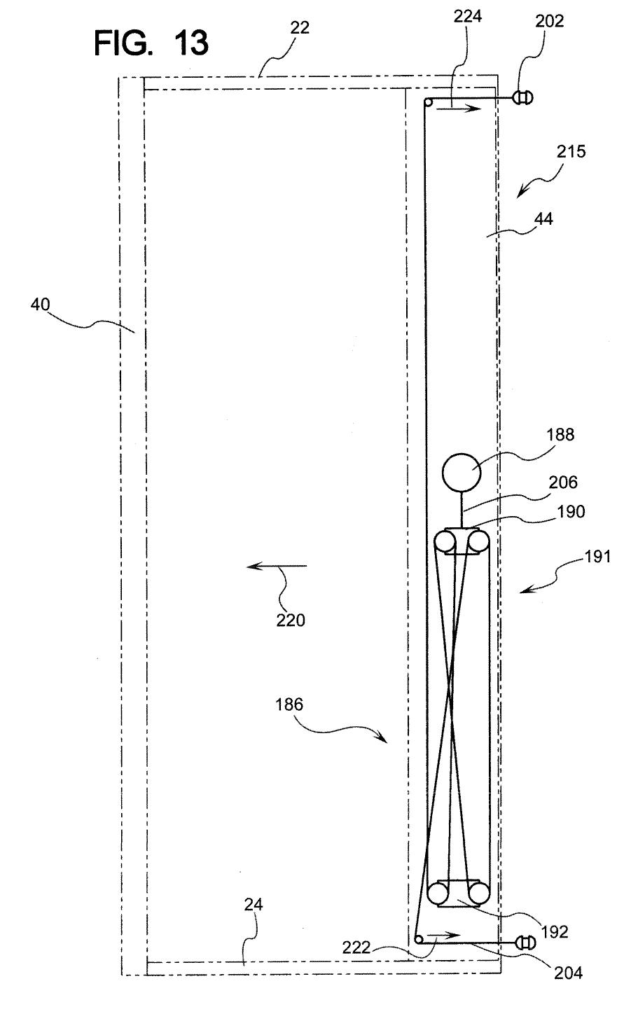

Reference is now made to FIG. 13, which shows a highly schematic system where the screen dispenser 40 is positioned in the left-hand portion, and the cover and lower bracketing components 22 and 24 are schematically shown by a hatched line. Further, the handle 44 is shown highly schematically, where the first and second ends 202 and 204 are schematically indicated to be fixed to the distal end portions 208 and 210 of the upper and lower bracketing components 22 and 24 respectively (see FIG. 9.) However, FIG. 13 schematically shows one form of pulley system 191 where the biasing member 188 is schematically shown having an extension 206 extending therefrom. In general, the biasing member 188 is a spring-like member and can be any number of types of springs. However, certain biasing members such as constant force springs appears to have the property of a constant force or a substantially constant force pulling therefrom. FIG. 13 illustrates the general principle that the force acting upon the handle 44 based from the counter-biasing system creating a counter-biasing force where it is schematically indicated how the screen induced force 220 is pulling in a first lateral direction toward the handle 44. To counteract this force, which is really a function of the wind up spring as shown in FIG. 7, the cord 200 at the upper and lower locations supplies a counteracting force that is schematically indicated by the vectors 222 and 224. Basically, some of these vectors should be substantially zero where the handle will stay in any orientation along the track. Further, this prevents the handle from slamming shut when the wind-up spring takes in the screen as described above. Therefore, with the foregoing disclosure in place, it can be appreciated that the various components comprise the counterbalancing system to properly balance the forces in the lateral direction acting upon the handle 44. Of course, it should be noted that the preferred form of arranging the pulley is shown in a manner similar to that shown in FIG. 9, where the center axis for the first pulley members 190 is substantially orthogonal to that of the second pulley members 192. However, for the sake of explanation, in FIGS. 13-17 it is shown highly schematically to illustrate the cord path for the various pulleys.

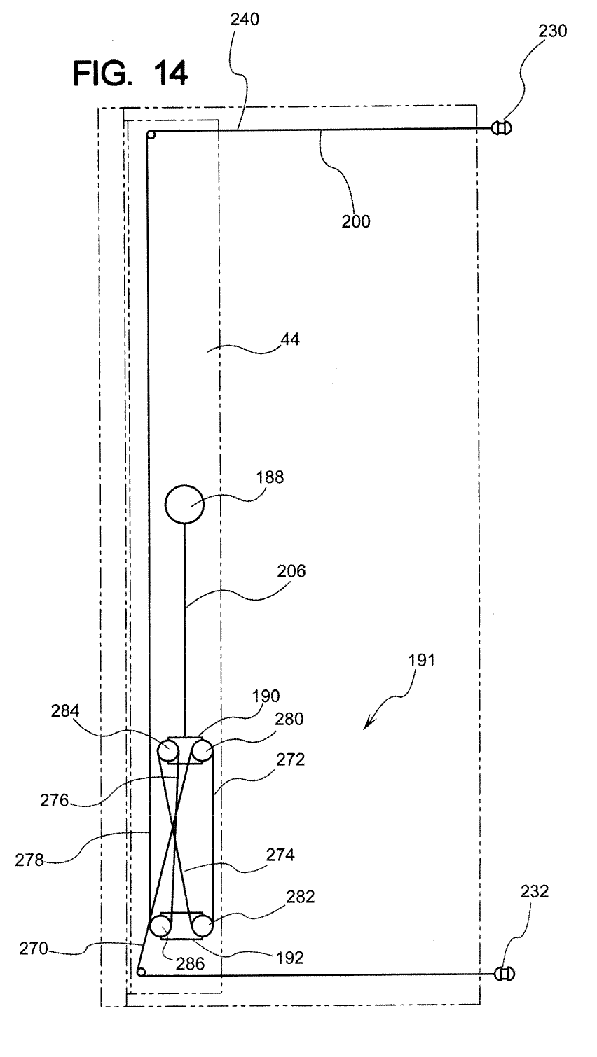

Referring to FIG. 14, it can be seen how the cord 200 which can be any type of flexible material, and in a preferred form is one continuous piece of material. However, this material is defined in certain sections where an upper section 240 extends from the handle 44 and is terminated at the first anchor point 230. In a similar manner, the lower balancing cord portion 242 extends from the handle 44 and is anchored at the second anchor point 232. In a preferred form the anchor points 230 and 232 are the end portions of the upper and lower bracketing members 22 and 24 but in other forms could be say for example a portion of the door frame.

In FIG. 14 the biasing member 188 is shown in a high-energy state where the internal spring-like mechanism of the biasing member is wound to store potential energy therein. The extension 206 is in an extended configuration where the first pulley member 190 is in closer proximity to the second pulley member 192. Where in the form where the cord 200 is substantially non-elastic, the net length of the cord does not substantially change so the having the pulley members be biasedly positioned away from one another creates the tension in the upper and lower balancing cords sections 240 and 242.

As shown in FIG. 14, in one form the pulley assembly 191 is positioned beneath the handle (as shown in FIG. 8). FIG. 14 schematically shows the path of the cord whereby the portion 270 extends around the pulley member 280 and then extends back around to the pulley member 282, which is a portion of the second pulley member. Thereafter, the extension portion 274 extends up and around the pulley 284 of the first pulley member 190 and extends back around a portion 276 around the pulley 286 and finally back up the long vertical length 278 which passes past an opening in the handle portion. As shown in FIG. 2, the handle indentation 290 is an inward recess portion for grabbing the unit. The adjacent open portions 292 and 294 are generally slender enough to allow a cord to pass therethrough. In one form, the first pulley member 190 is too large of a unit to pass around such a portion. That is why, in one form, first and second pulleys 280 and 284 of the first pulley member 190 are utilized in conjunction with the first and second pulleys 282 and 286 of the second pulley member 192 are shown in FIG. 14. Of course a block and tackle-like pulley assembly allows for a greater amount of extension of the portions 240 and 242 with respect to the displacement of the first and second pulley members 190 and 192 as they travel towards one another.

Referring back to FIG. 13, it can be seen how the first and second pulley members 190 and 192 are positioned apart from one another and the biasing member 188 is in a lower energy state and the extension 206 is wound therein.

Referring back to FIG. 9, there is shown a less schematic version of the unit where the lower and upper portions 182 and 188 of the handle 44, have track members 300 and 302 which are adapted to extends in the upper and lower bracketing members 22 and 24. It should be noted that the cord diversion member 185 in one form is a static type member which provides a slight frictional engagement of the balancing cord passing therearound. Of course in one form the pulley-like member could be applied here; however, it has been found that having a slight frictional resistance of the cord passing around the substantial 900 angle creates a slight dampening effect as the handle is repositioned in the lateral direction.

As shown in FIG. 12, the upper bracketing member 22 is shown where the upper track member 312 has the inlet 304 that is adapted to travel within the chamber region 306 of the chamber 306. Referring to FIG. 12, it should be noted that in one preferred embodiment, the upper and lower attachment portions of the handle member are not adapted to have a torque about the transverse axis 10′. In other words, if the handle has any substantial amount of torque applied to it about a transverse axis, the handle will tend to get skewed within the upper and lower bracketing members 22 and 24. In other words, because in one form the bracket members substantially terminate at the fully opened orientation of the handle, and further the bracketing members do not extend beyond the base housing 51, there is no opportunity to provide any laterally extending structure within the bracket members that is attached to handle to counteract any torque placed on the handle about the transverse axis.

In general, the upper track member 22, in one form, is similar to the track members as shown in U.S. Pat. No. 6,478,070 where essentially the interior partially circular member 308 can rotate with respect to the outer member 310. Of course, this allows for some of variability in the orientation of the outer member 310 where the inner member can be aligned in a manner where the laterally extending slot 312 is substantially perpendicular to the neck region 314 of the inlet 304.

Referring back to FIG. 9, it can be seen that the inlet portion 304 provides a base holder (or base holder surface) 320 which is adapted to support the lock end 322 and 324 in the lower portion of the unit. Basically, the tension placed upon the upper and lower extension portions 240 and 242 of the cord 200 initially biases the lock ends 322 and 324 in the base holder 320 where the rearward portion of the lock end 322 nestles within the base holder 320. It should be noted that this initial orientation of the lock end 322 being nestled into the base holder 320 is only upon the first installation. After the door is opened and slammed wide open once, as shown in FIG. 11B, the lock member 322 is adapted to engage the locking extensions 340 in a manner as shown in FIG. 11C. Basically, the locking extensions 340 extend radially inwardly, and engage the annular groove 342 of the locking extension. FIG. 11A shows a bottom view of the distal end portion 208 where an access port allows for the locking extensions to be pried open to release the lock end 322 in case the unit must be disassembled for some reason.

It should be noted that the distal end portion 208 comprises a threaded receiving portion 350 which is adapted to have, for example, a double threaded screw or the like pass therethrough.

It should be reiterated that the steps as shown in FIGS. 11B-11C are only executed the first time the doors completely open. Thereafter, the lock end 322 is attached to the distal end portions 208 and 210 as shown in FIG. 9.

With the foregoing description in place, there will now be a brief discussion of other potential embodiments. Referring now to the schematic embodiment FIG. 15, in this form, the biasing member 188 is fixedly attached to the frame member in a similar manner within the handle as described above. However, in this form, the second biasing member 188′ is also placed therein, therefore the first and second pulley members 190′ and 192′ are both movable in the chamber portion of the housing. As long as there is a certain amount of biasing resistance from the unit to inhibit the motion of the first and second pulley members from becoming closer to one another, the counterbalancing force of the upper and lower regions 240 and 242 is achieved.

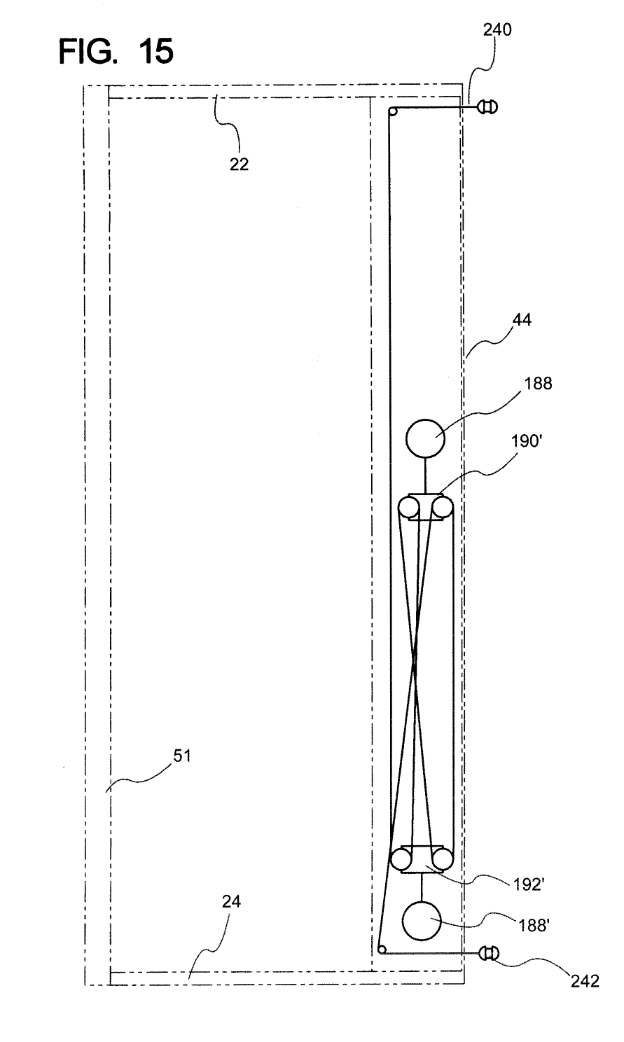

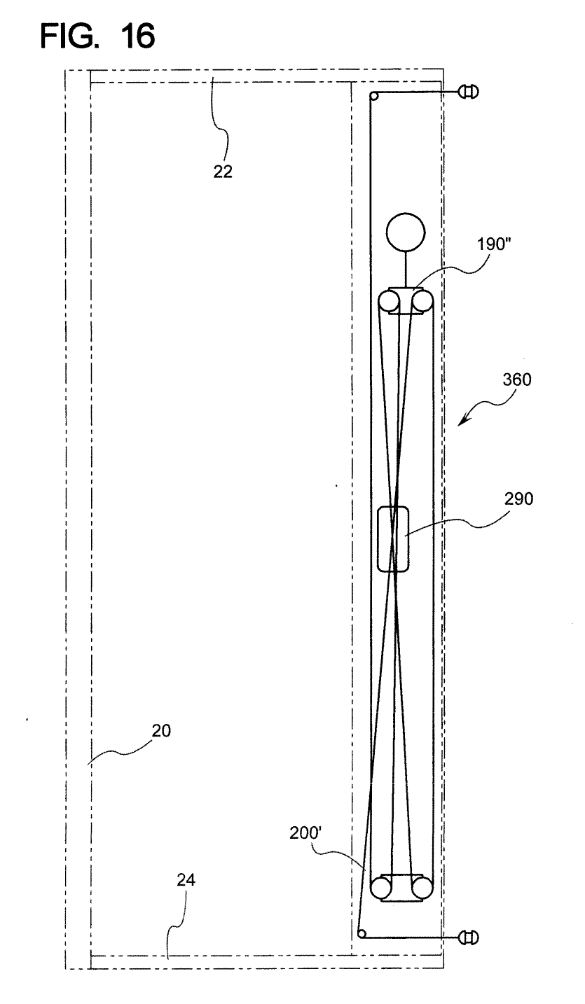

Referring now to FIG. 16, there is shown another embodiment, where in this form, the first pulley member, for example 190″ is positioned above the handle portion 290. Of course the various portions of the cord indicated at 360 would likely be positioned in the chambers 292 and 294 as shown in FIG. 2. However, for the purposes of illustrating the path of the cord 200′, there is shown a more schematic version.

The area 189 is a grasping region as shown in FIG. 2. In many forms it is desirable to have a grasping portion opposite to the handle member 47 on the opposing side. However, the forward and rearward chamber regions 292 and 294 are formed within the interior chamber 293 (see FIG. 8) of the handle 44. It should be noted that the embodiments such as that shown in FIGS. 13-17 are schematic, and the cords, when positioned on opposing sides of the grasping region 189, would travel around a perimeter portion of this indentation. For example, FIG. 16 shows a schematic form of one method of extending the balancing cord around the upper and lower pulley members. However, the pulley members would be orientated in a manner similar to that shown in FIG. 9 so the cords would extend to regions such as 292 and 294 as shown in FIG. 2.

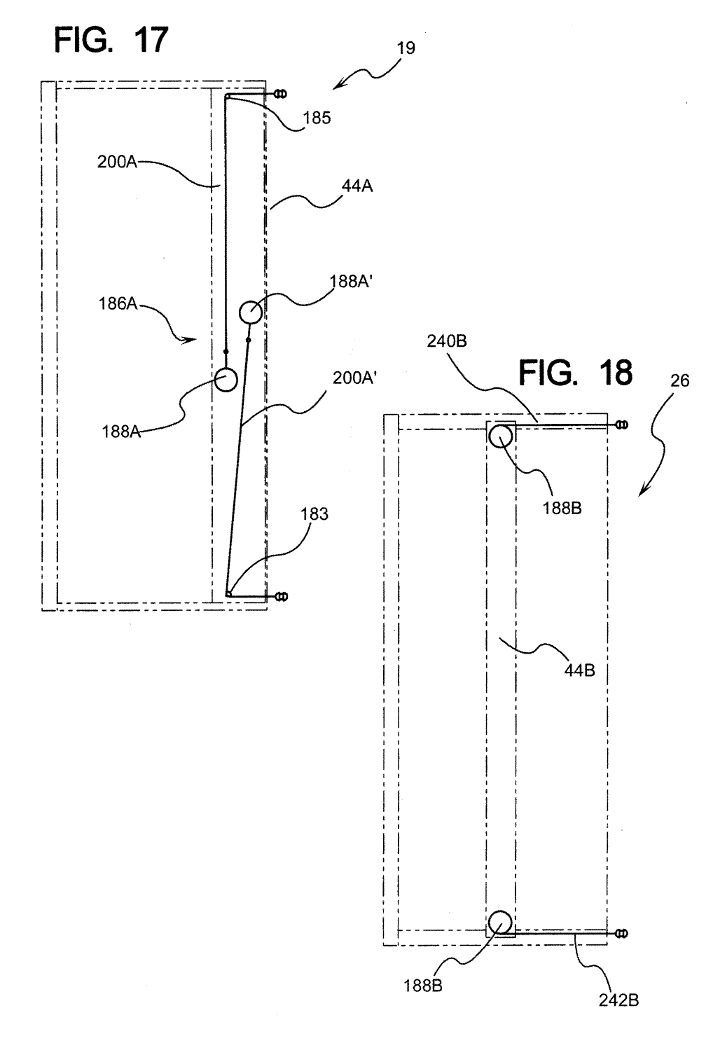

Now referring to FIG. 17, another embodiment where in this form, the biasing members 188A and 188A′ are positioned in upper and lower portions within the handle 44A. The cord sections 200A and 200A′ extend around the cord diversion members 185 in a similar manner as shown in FIG. 9. In this form, a counterbalancing force is utilized, except instead of a block and tackle assembly, the cord elongation assembly 186A basically comprises two biasing members.

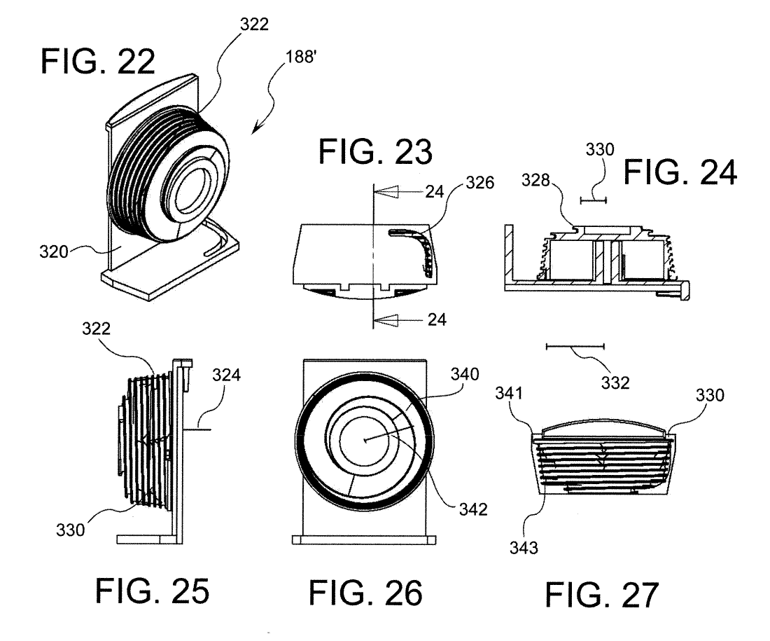

FIG. 18 shows another embodiment where the upper and lower biasing members 188B can, for example, have a cord extending therefrom. The biasing members 188B could for example be the mechanism as shown in FIGS. 22-27 described herein where the extendable string serves directly as the upper and lower balancing cords 240B and 242B. Of course in this configuration, the radially interior portion 330 of the spool would be positioned radially inwardly, whereby as the spool is more tightly wound, a jolt of greater force would be calibrated when the handle 44B is about to be fully extended with the screen being in a fully screen extended configuration.

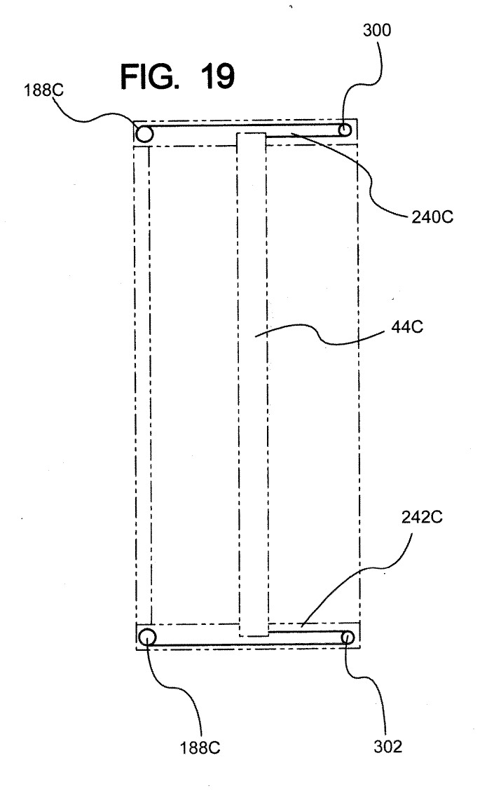

Now referring to FIG. 19, there is shown another embodiment where the upper and lower biasing members are biasing cords 240C and 242C are positioned around the pulley members 300 and 312, where for example, the biasing members 188C and 188C′ are operatively configured to retract the cord sections extending around the pulleys 300 and 302 respectively. Of course the spring members could be attached to, for example, the handle member 44C.

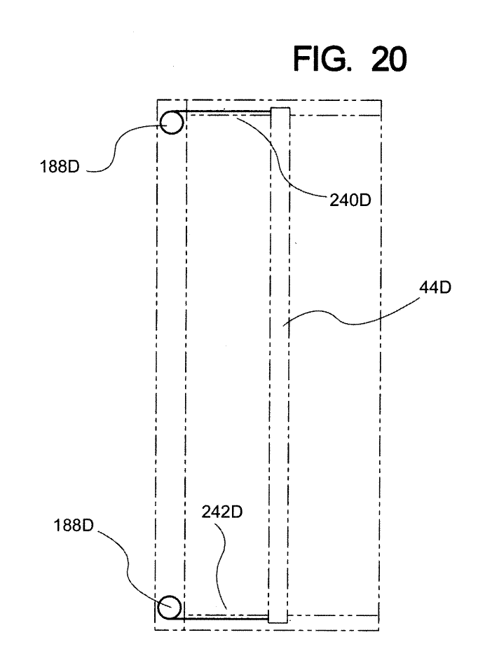

FIG. 20 shows another embodiment where the balancing cord 240D and 242D in one form can comprise an incompressible type linkage assembly such as a chain that is housed within a housing 306. The unit is configured to forcefully unwind from the schematic biasing member 188D. Of course, a similar type of configuration would be positioned in the lower portion of the handle member 44D. The balancing cords 240D and 242D are basically an incompressible extendable member similar to, say, an extendable and retractable measuring tape. The cross-sectional area of this member can be non-planar to have a certain amount of buckling resistance. Of course this member can further be positioned within some form of a tube or elongate structure to mandate of force upon the upper and lower portions of the handle in the first lateral direction and be configured of material as say for example a chain link structure.

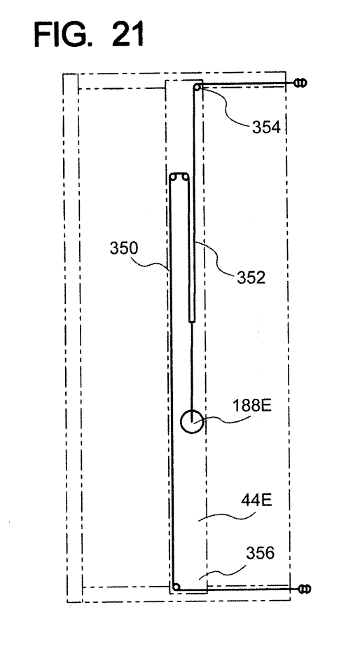

FIG. 21 shows yet another embodiment where the biasing member 188E is attached to first and second balancing cords 350 and 352 which extend up around the portions 354 and 356 of the handle 44E. Of course, this and other alternatives show various forms of producing a counteracting force other than a frictional force at the upper and lower portions of the handle member.

FIGS. 22-27 shows an embodiment of one type of biasing member 188 which in this form is a partial constant force spring. As shown in the figures, the biasing member 188′ generally comprises a housing 320 and a wind-up spool 322. The wind-up spool 322 has a frustoconical property where the lever arm from the center axis 324 decreases as the spool unwinds. In general, the internal spring mechanism to the constant force spring 188′ generally increases torque as it is in a higher energy state, which is normal with the spring constant of most materials and wind-up spring-like mechanisms. However, decreasing the diameter of the string pull essentially gives a lower moment arm which, if designed properly, can provide a substantially constant force applied to the cord (not shown) which is wrapped around the wind-up spool 322. The opening which is defined by the surrounding surfaces indicated at 326 can allow disbursement of the cord.

As shown in FIG. 23, the wind-up spool comprises the decreased diameter helical-like portion 340 which gradually decreases the diameter of the pull of the cord wrapped therearound, where this diameter is indicated at 342.

As the spring is fully unwound, the diameter can change in a manner as shown in FIG. 24 where the last portion of the pull can substantially reduce the diameter indicated at 328. This, for example, reduces the lever arm indicated at 330 from, where for example, the lever arm indicated at 332 by a factor of 1:2 in one form, one unit of a unit of length 330 compared to the length of 332 can be 1.2-2.5 length units for example. The size of the spool and the length can be configured in a manner so that when the handle is in the configuration and is about to be closed so is extra tension in the balancing cords right when the screen closes. This gives a desirable effect where, for example, the tension in the line wrapped around the wind up spring is say 3 pounds, it can increase to 5 pounds through the last bit to ensure that the handle is in a screen extended configuration. This gives an effect similar to say a fridge door closing by way of pressure differentials from within and without any outside portion of the fridge. Further, in general, individuals generally may intend the screen of the open extended configuration they desire it to be fully open. The extra force generated in the cord elongation assembly 186 as shown in FIG. 9 can be generated by the modified wind-up spring 188′.

Now referring back to FIG. 18, it should be noted that biasing members 188C could be similar to the biasing member 188′ shown in FIGS. 22-27. As noted above, FIG. 18 shows biasing members 188C the attached to the lower and upper portions where the biasing member directly attached or is a part of the upper and lower balancing cords. In this embodiment the inward portion 341 as shown in FIG. 27 would be narrower (to say the diameter shown at 330 in FIG. 24) in diameter to allow a greater amount of force to be generated when the wind-up spool 322 fully winds up the balancing cord and is about to fully extend the screen at say two to three inches from fully extended position.

The various figures, namely FIGS. 13-21, show various handle biasing means that are configured to provide a counterbalancing force in the substantially opposite direction as the force exerted by the screen. Of course, if, for example, the upper and lower bracketing members 22 and 24 were not straight, they could be arced, for example where the force of the screen and the upper and lower balancing cords would not be perfectly planar.

Therefore I claim:

1. A screen door system comprising
a. a screen dispenser having an outer shell which houses a spring-loaded screen extension system, the spring-loaded screen extension system comprising a screen that is operatively configured to extend from the screen dispenser,
b. an upper bracketing component and a lower bracketing component positioned at upper and lower portions of the screen door system, respectively,
c. a handle movably positioned between the upper bracketing component and the lower bracketing component, the handle having an interior chamber housing,
d. a pulley system having a first pulley member and a second pulley member where the first and second pulley members are operatively configured to reposition in closer proximity to one another within the interior chamber where a force is required for positioning the first and second pulley members together,
e. a balancing cord having a first end and a second end and a medial region, the medial region being adapted to extend around the first pulley member and the second pulley member where repositioning the handle of the screen door system to a closed screen configuration repositions the first pulley member and the second pulley member to a location closer to one another within the interior chamber and repositioning the handle member of the screen door system to an open screen configuration repositioning the first and second pulley members at a further apart location with respect to the interior chamber.

2. The screen door system as recited in claim 1 where the first and second ends of the balancing cord can have a locking end that are adapted to be received within distal end portions positioned on the upper and lower bracketing components.

3. The screen door system as recited in claim 1 where the handle has upper and lower edge portions that are adapted to extend within the upper and lower bracketing components respectively.

4. The screen door system as recited in claim 1 where the first pulley member is attached to a biasing member and the biasing member comprises a constant wind-up spool having a non-linear diameter where in the last portion of extension of the wind-up spool, the diameter substantially decreases to increase the amount of force upon the first pulley member.

5. A screen door system comprising:
a. a base housing comprising upper and lower portions,
b. upper and lower bracketing components attached to the upper and lower portions of the base housing and each having opposing end portions,
c. a handle having upper and lower locations and the handle is connected to the screen and movably positioned to operate along the upper and lower bracketing components at the upper and lower locations respectively,
d. a counterbalancing system comprising:
i. an upper balancing cord that extends from an upper portion of the handle and is attached to an end portion of the upper bracketing component where the first balancing cord places a force upon the upper portion of the handle in a first lateral direction,
ii. a lower balancing cord extending from the lower portion of the handle and attached to the end portion of the lower bracketing component where the second balancing cord places a force upon the lower portion of the handle in a first lateral direction
e. a screen dispensing and retracting system positioned substantially within the base housing and operatively configured to have a screen extract therefrom and place a force upon the handle in a second lateral direction.

6. The screen door system as recited in claim 5 where the upper and lower cord portions substantially counterbalance the force exerted upon the handle by the screen by way of the screen dispensing and retracting system.

7. The screen door system as recited in claim 5 where first end portions of the upper and lower balancing cords are attached to end caps located at the opposing end portions of the upper and lower bracket components.

8. The screen door system as recited in claim 7 where the first end portions of upper and lower balancing cords have end lock members that are adapted to engage locking extensions of the end caps.

9. The screen door system as recited in claim 5 where the upper and lower balancing cords are connected to one another and extend around a pulley assembly where the pulley assembly comprises first and second pulleys that are orientated within the handle biasedly positioned away from one another.

10. The screen door system as recited in claim 9 where the first and second pulleys are a block and tackle pulley assembly each having two pully members where a central portion of a balancing cord is wound therearound the first and second pulleys where one end of the central portion of the balancing cord extends through the handle to comprise the upper balancing cord and the other end of the central portion of the balancing cord extends through the handle to comprise the lower balancing cord

11. The screen door system as recited in claim 10 where the first pulley member is fixedly attached to an interior portion of the handle, and the second pulley is movably attached therein and attached to a spring member to bias the second pulley away from the first pulley.

12. The screen door system as recited in claim 5 where the base housing is comprised of a base shell and an outer shell, where the base shell comprises a rotating receiving slot where a locking extension in the outer shell is operatively configured to be rotatably mounted therein at a first lateral location.

13. The screen door system as recited in claim 12 where a locking extension is positioned at a second lateral location where a locking extension is adapted to be received at the lower and upper portions of the base housing.

14. A balanced screen door apparatus comprising:
a. a base frame unit having upper and lower laterally extending members, the upper and lower laterally extending members each having first and second lateral locations, the upper and lower laterally extending members connected to a base housing at the first lateral location, the base housing operatively configured to house a screen dispensing mechanism which provides for a vertically extending slot for extracting a spring retractable screen therefrom, the spring retractable screen having a first end that is attached to a handle member, the handle member having an upper end location where the handle member is attached to the upper laterally extending member, the handle member having a lower location attached to the lower laterally extending member,
b. an upper balancing cord operatively connected between the second lateral location of the upper laterally extending member and the upper portion of the handle member to be biasedly connected to apply a force on the upper portion of the handle member in a first lateral direction,
c. a lower balancing cord operatively connected between the second lateral location of the lower laterally extending member and the lower portion of the handle member, and the lower balancing cord is operatively configured to apply a force in the first lateral direction at the lower portion of the handle member whereas the screen places a force on the handle in a second lateral direction.

15. The balanced screen door apparatus as recited in claim 14 where the upper and lower balancing cords each comprise a first end that is attached to the upper and lower portions of the handle member and the upper balancing cords each extend around an upper pulley member that are positioned in the second lateral locations of the upper laterally extending member and lower laterally extending members respectively, and each of the balancing cords are wrapped therearound an upper and lower pulley and are operatively attached to a retraction member.

16. The balanced screen door apparatus as recited in claim 14 where the attachment between the handle member and the upper laterally extending member can not counter a torque placed thereon about a transverse axis.

17. The balanced screen door apparatus as recited in claim 15 where the retraction member is a constant force spring.

18. The balanced screen door apparatus as recited in claim 14 where the upper balancing cord comprises an incompressible extending member which is attached to the upper portion of the handle member, and compressively applies a force in the first lateral direction where the balancing cord is positioned between the handle member and the base housing.

19. The balanced screen door apparatus as recited in claim 18 where the balancing cord has a cross section that is non-planar.

20. The balanced screen door apparatus as recited in claim 14 where the upper and lower balancing cords comprise a balancing cord where the upper and lower balancing cords are connected to one another and extend within a chamber region of the handle member around a first pulley member and a second pulley member where the first and second pulley members are biased away from one another to create tension in the balancing cord.

21. The balanced screen door apparatus as recited in claim 20 where the first and second pulley members are biased away from one another where one pulley member is attached to a spring which is attached to the inner portion of the handle.

22. The balanced screen door apparatus as recited in claim 21 where the first and second pulley members and the biasing member are positioned below a handle indentation of the handle member.

23. The balanced screen door apparatus as recited in claim 21 where the first and second pulley members and the biasing member are position above a handle indentation member.

24. The balanced screen door apparatus as recited in claim 21 where upper and lower balancing cords have lock end portions and the upper and lower portion of the handle member comprises a base holder that is adapted to house the lock end portions, the lock end portions of the upper and lower balancing cords being operatively configured to be connected to the second lateral locations of the upper and lower laterally extending members.

25. The balanced screen door apparatus as recited in claim 20 where the axis of rotation of the first pulley member is substantially perpendicular to that of the second pulley member.

26. The balanced screen door apparatus as recited in claim 25 where the first pulley member is attached to a constant force spring which in turn is attached to the interior portion of the housing.

27. The balanced screen door apparatus as recited in claim 24 where the second lateral location of the upper and lower laterally extending members comprise distal end portions having locking extensions that are adapted to engage an annular groove of the lock and attach to the end portion of the upper and lower balancing cords.

28. The balanced screen door apparatus as recited in claim 27 where an access port is provided in the distal end portions to disengage the locking extensions from the annular groove of the lock end.

29. The balanced screen door apparatus as recited in claim 20 where the first pulley member comprises two pulley units and the second point member comprises two pulley units where the balancing cord extends around the pulley units of the first and second pulley members to provide a block and tackle pulley arrangement.

30. The balanced screen door apparatus as recited in claim 29 where the base housing comprises a base shell that is operatively configured to be attached to an outer shell, the base shell having a longitudinally extending slot that is adapted to receive a locking extension of the outer shell and a rotatable insert about a vertically oriented axis where the outer shell is operatively configured to lock to the base shell at upper and lower portions to contain the screen dispensing mechanism therein.

31. The balanced screen door apparatus as recited in claim 14 where the base housing comprises a base shell that is operatively configured to be attached to an outer shell, the base shell having a longitudinally extending slot that is adapted to receive a locking extension of the outer shell and a rotatable insert about a vertically oriented axis where the outer shell is operatively configured to lock to the base shell at upper and lower portions to contain the screen dispensing mechanism therein.

32. The balanced screen door apparatus as recited in claim 14 where the screen dispensing mechanism has a spring tension adjustment system to adjust a rotational torque placed on the screen to bias the screen in the second lateral direction.

33. The balanced screen door apparatus as recited in claim 32 where the screen dispensing mechanism comprises an inner plug that is adapted to be vertically displaced within an elongate tube where a static plug is attached to the base housing and a first end of a spring is attached to a static plug and a second end of the spring is attached to the inner plug which transfers a rotational torque to the elongate tube which has a screen wrapped therearound.

34. The balanced screen door apparatus as recited in claim 33 where the static plug is attached to an adjustment cap where the adjustment cap is configured to increase the tension upon the spring when rotated with respect to the base housing.

35. The balanced screen door apparatus as recited in claim 32 where the spring tension adjustment system is adjustable to provide a force upon the handle in the second lateral direction by way of the screen that is substantially balanced to the force applied upon the handle in the first lateral direction by the upper and lower balancing course.

36. A screen door system comprising a base frame unit having upper and lower laterally extending members that are attached to a base housing that extends in a vertical direction, the upper and lower laterally extending members being slideably connected to a handle member that is repositioned from a closed orientation to an open orientation, when the handle is an open configuration a screen is extracted from the base housing and withdrawn from a spring-loaded screen extension system contained in the base housing, the screen door system further comprising a handle biasing means which comprises upper and lower balancing cords that are attached to the upper and lower portions of the handle to provide a force that is substantially opposing the force of the screen acting upon the handle.

37. The screen door system as recited in claim 36 where a cord retraction system comprises first and second pulley members that are configured to be biased away from one another where the upper and lower cords are part of a single unitary cord extending the around the first and second pulley members.

38. The screen door system as recited in claim 37 where the first pulley member is attached to a biasing member and the biasing member comprises a wind-up spool having a non-standard diameter where in the last portion of extension of the wind-up spool, the diameter substantially decreases to increase the amount of force upon the first pulley member.

39. A method of installing a screen door on a door frame having first and second lateral regions and lower and upper perimeter regions, the method comprising:
a. rigidly attaching a base frame unit comprising a substantially vertically oriented base housing,
b. attaching an upper laterally extending member and a lower laterally extending member to the upper and lower perimeter region of the door frame, the upper and lower laterally extending members having distal ends that oppose the portions of the upper and lower laterally extending members that are connected to the base frame unit,
c. positioning a handle member to be slideably attached to travel between the upper and lower laterally extending members,
d. providing a screen positioned within the base housing where the screen is retractably withdrawn from a screen extension system contained within the base housing,
e. attaching a first vertically extending end of the screen to the handle, the handle comprising an interior chamber that houses a cord retraction system, the cord retraction system comprising:
i. a cord member having an upper cord and a lower cord where the upper and lower cord ends retractable extend in a first lateral direction to the upper and lower portions of the handle respectively, the upper and lower cord ends having a end locks adapted to be housed within base holder surfaces which are located in the upper and lower portions of the handle,
f. repositioning the handle to a fully extended configuration whereby the upper and lower end locks of the upper and lower cords are received by an upper and lower locking mechanisms positioned at the laterally distal ends of the upper and lower laterally extending members,
g. thereafter retracting the handle toward the base housing where the end locks of the upper an lower cords are now statically positioned at the distal end portions of the upper and lower laterally extending members.

40. The method of installing a screen door as recited in 39 where the base holding surface is a partially spherical surface which is adapted to receive a rearward male spherical surfaced portion of the end lock where the tension in the upper and lower balancing cords positions the rearward male spherical portion of the end lock within the spherical portion of the base holding portion of the upper and lower handle portions of the handle.

41. The method of installing a screen door as recited in 40 where a cord retraction system comprises first and second pulley members that are configured to be biased away from one another where the upper and lower cords are part of a single unitary cord extending the around the first and second pulley members.

42. The method of installing a screen door as recited in 41 where the first and second pulley members are respectively attached to the first and second spring members.

43. The method of installing a screen door as recited in 41 where the cord retraction system is positioned below a handle indentation within the handle.

44. The method of installing a screen door as recited in 41 where the cord retraction system is positioned above a handle indentation which forms a grasping region in the handle.

45. The method of installing a screen door as recited in 39 where base housing is comprised of a base shell and an outer shell, the outer shell which is pivotally attach at one portion of the bas shell and snapped to an opposing portion of the base shell.

46. The method of installing a screen door as recited in 41 where the first and second pulley members are each attached to spring-like members.

47. The method of installing a screen door as recited in 41 where the first pulley member is attached to a biasing member and the biasing member comprises a partially constant wind-up spool having a non-standard diameter where in the last portion of extension of the partially constant wind-up spool, the diameter substantially decreases to increase the amount of force upon the first pulley member.
